(19) United States
(12) Patent Application Publication
(10) Pub. No.: US 2020/0055143 A1
(43) Pub. Date: Feb. 20, 2020

(54) METHOD AND DEVICE FOR MACHINING A MATERIAL LAYER USING ENERGETIC RADIATION

(71) Applicant: FRAUNHOFER-GESELLSCHAFT ZUR FORDERUNG DER ANGEWANDTEN FORSCHUNG E.V., Muenchen (DE)

(72) Inventors: REINHART POPRAWE, Aachen (DE); FLORIAN EIBL, Aachen (DE); WILHELM MEINERS, Aachen (DE); LUCAS JAUER, Herzogenrath (DE)

(21) Appl. No.: 16/346,203

(22) PCT Filed: Nov. 9, 2017
(86) PCT No.: PCT/EP2017/078738

§ 371 Date: Apr. 30, 2019

(30) Foreign Application Priority Data
Nov. 10, 2016 (DE) 10 2016 222 067.5

(51) Int. Cl. B23K 26/342; B33Y 10/00; B33Y 30/00; B33Y 50/02; B23K 26/082; B23K 26/06; B23K 26/067

(52) U.S. Cl. CPC B23K 26/342; B33Y 10/00; B33Y 30/00; B33Y 50/02; B23K 26/0676; B23K 26/0608; B23K 26/0643; B23K 26/0652; B23K 26/082

(57) ABSTRACT

The invention relates to a method and a device for machining a material layer using energetic radiation to produce three-dimensional components by melting a particulate material in layers. In the method, one or more energetic beams of one or more beam sources are directed onto a layer to be machined and guided over the layer by a dynamic beam guidance system. The method is characterized in that at least one of the energetic beams is divided into multiple individual beams by modulation over time, which are directed onto the layer to be machined in a spatially separated manner. The separation is carried out such that the sum of the power of the individual beams corresponds to the power of the respective energetic beam minus power losses caused by the separation process.

### TECHNICAL FIELD

The present invention relates to a method and a device for machining a material layer with energetic radiation, in particular in order to produce three-dimensional components by melting a particulate material in layers, in which one or more energetic beams from one or more beam sources are directed onto a layer of the material that is to be machined and guided over the layer by means of a dynamic beam guidance system in order to machine regions of the layer.

In powder-bed based beam fusion methods such as Selective Laser Melting (SLM), three-dimensional components are prepared additively directly from 3D CAD models. In an iterative process, a thin layer of powder, typically less than 100 μm thick, is applied to a substrate plate with a spreading mechanism, and in a subsequent step is melted selectively according to the geometry information contained in the 3D CAD model with the aid of one or more energy beams, particularly laser beams. This cyclical process enables the production of three-dimensional components with few limitations in terms of structural complexity. In SLM, the compaction of the component depends on complete melting of the powder and the preceding layer. In this way, it is possible to achieve component densities of up to 100% and mechanical properties comparable with conventional manufacturing methods.

In such a method, the process chain is carried out sequentially relative to a construction platform within the production plant, as is shown diagrammatically in FIG. 1. The value-adding irradiation process, in which the corresponding regions of the layer are melted selectively with the energy beam, is interrupted by non-value adding processes which as layer application, process preparation and follow-up processing. Depending on the plant equipment used, if galvanometer scanners are used to steer the beam, for example, the value-adding irradiation process is further interrupted by technically unavoidable irradiation dead times, during which the scanner mirrors needed to deflect the beam are moved, but no irradiation takes place. This is the case for example when scan vectors which are to be irradiated one after the other are not geometrically directly adjacent to each other. Other non-productive times also occur during “skywriting”, the acceleration and deceleration phases of the scanner mirrors. The beam source is thus not used to its full capacity for irradiation.

### RELATED ART

Alternative irradiation concepts are also known besides the beam deflection systems based on galvanometer scanners with upstream or downstream focusing optics used predominantly in the past. These are mostly less complex optics systems, which are guided over the surface to be irradiated by means of a movement device. This offers the advantage of enabling possible scaling of the dimensions of the installation space and/or the melting power without having to change the basic plant structure.

Thus for example WO 2015/003804 A1 discloses a device in which an irradiation or processing head is moved over a powder bed with the aid of an axis system. The processing head uses an optical device to project a plurality of laser beams in a fixed position assembly side by side as laser spots or partially overlapping onto the processing plane, e.g., in a linear arrangement perpendicularly to the direction of movement of the processing head. In this context, the laser beams are each generated by a separate beam source, guided to the processing head via optical fibres, and modulated or switched on and off depending on the component geometry to be created simultaneously with the movement of the processing head. Document WO 2014/199149 A1 discloses a similar device, in which the respective beam sources direct the radiation directly onto the processing plane without any optical fibres. However, these devices need a separate beam source for each individual laser spot in the processing plane. This does mean that the spot arrangement can be widened practically without limit by increasing the number of beam sources. But it is also associated with a linear increase in costs. Moreover, the cost of construction is increased correspondingly.

US 2014/0198365 A1 describes an irradiation device in which the radiation from a single beam source is separated into a plurality of partial beams by means of one or more beam splitters. The partial beams are then each directed separately and independently onto the processing plane by their own deflection units. With this arrangement, however, given the constant separation of the laser power among the individual partial beams, arrangements must be made to ensure that the area to be irradiated by the respective beam deflection devices is identical.

Document WO 00/21735 A1 suggests an irradiation device in which the emission from one light source is directed at the processing plane via a plurality of individual optical fibres which are arranged in a fixed position array. A light valve is attached behind each fibre end and is able to either transmit or absorb the radiation emerging from the fibre depending on a control signal. In this way, areas belonging to the component can be irradiated selectively in the processing plane by the movement of the fibre array and the controller which is dependent on the component geometry of the light valves. During operation of this device, the radiation of certain irradiated areas, which are not needed for constructing the component must be absorbed in the associated light valves. In practical use, however, this leads to a very low ratio between the laser power generated and the laser power actually used. This also applied for some of the devices described earlier.

The disadvantages of the known devices described above make it more difficult to use powder bed based laser beam melting methods economically, in serial production of metal components for example.

The object of the present invention is to describe a method and a device for machining a material layer using energetic radiation, particularly for manufacturing three-dimensional components by layered melting of a particulate material with laser radiation, which enables improved exploitation of the beam sources employed without thereby being limited to certain surfaces to be irradiated.

### SUMMARY OF THE INVENTION

The object is solved with the method and the device according to Claims 1 and 9. Advantageous variants of the method and the device are the subject matter of the dependent claims or may be understood from the following description and exemplary embodiments.

In the suggested method, one or more energetic beams from one or more beam sources are directed in known manner onto a layer of the material that is to be machined and guided over the layer by a dynamic beam guidance system, to process, in particular melt, regions of the layer. The suggested method is characterized in that at least one of the energetic beams is divided into several individual beams by modulation over time, these beams being directed onto the layer that is to be machined in spatially separate manner, i.e. by means of different beam guidance systems and/or beam deflection elements. In this context, separation by modulation over time is understood to mean that a temporal separation of the beam onto the spatially separate individual beams is made. The separation is performed in such manner that the sum of the power of the individual beams corresponds to the power of the respective energetic beam minus unavoidable power losses due to the optical components used. In a preferred variant, the separation into individual beams is performed in alternating manner, so that the individual beams never occur at the same time. The separation of the energetic beam into the individual beams may be performed at periodic time intervals. However, this is not essential. It is also not essential for the beam to be separated into individual beams with equal factions of the power, but only so that the sum of the temporal power distributions to the individual beams—minus any power losses due to the optical components used to perform the separation—corresponds to the original power distribution over time. The separation into the individual beams takes place in such manner that a continuous processing, for example continuous melting may be carried out with the energetic beam depending on the area to be processed in each case. The effect of the separation over time is that the full power of the energetic beam is used for the respective processing at any point in time during the irradiation or machining process. This enables uninterrupted or almost uninterrupted irradiation or machining, during which the utilisation rate of the beam source used is maximised. In a powder-bed based beam fusion method, this serves to increase the fraction of the total process time taken up by the value-creating process and to raise the productivity of the system compared with the known systems according to the related art. This is most advantageous particularly in the context of industrial serial production.

The suggested device for performing the method accordingly has one or more beam sources which emit one or more energetic beams, and at least one beam splitter device which is able to separate at least one of the energetic beams into multiple individual beams by modulation over time. The beam splitter device is designed such that the sum of the power of the individual beams upon separation is at least approximately equal to the power of the respective energetic beam. The apparatus further comprises one or more dynamic beam guidance devices, by means of which the individual beams may be directed to a layer of the material that is to be processed and guided over the layer in order to machine regions of the layer.

With the suggested method and the associated device, depending on the variant it is possible to use just a single beam source, which emits an energetic beam, which is divided correspondingly into several individual beams by modulation over time. It is also possible to use multiple beam sources, in which case each beam source then emits an energetic beam which is split correspondingly into multiple individual beams by modulation over time. Of course when several beam sources are used it is also possible only to divide the energetic beam of one or a fraction of the radiation sources in the manner described above.

The beam guidance apparatus may be configured in various ways. For example, a beam guidance apparatus may be used which is designed as with some of the devices of the related art described in the introduction to this specification as a machining head which is guided over the layer to be processed for irradiation or machining. Alternatively, the beam guidance apparatus may also include dynamic beam deflection units, in the form of galvanometer scanners, for example, which guide the individual beams over the layer that is to be processed by means of corresponding dynamic beam deflection. Other beam guidance techniques, such as micromirror arrays, mirror systems or polygon scanners or a combination of several techniques are also possible.

In an advantageous variant, each individual beam is directed onto the layer of the e.g., particulate material by means of its own dynamic beam deflection device. In this way, individual beams may be deflected dynamically and independently of each other.

In the following text, the suggested method and the suggested device will be explained with reference to the preferred application of manufacturing three-dimensional components by layered melting of a particulate material with energetic radiation. However, the method and device and the variants thereof are not limited to this application. They also offer similar advantages when used in other machining processes in which a material layer is processed with energetic radiation, in laser cutting for example.

In conventional beam melting processes with laser radiation, in which the radiation used for melting is guided over the powder bed according to the layer information of the component by means of beam deflection, for example with a galvanometer scanner, dead times may occur in which the beam is not directed at the powder bed. Thus in the case of galvanometer scanners sometimes the “skywriting” strategy is implemented to render the scanning speed and therewith the energy input more even. The deceleration and acceleration processes of the scanner mirror which are typically unavoidable during abrupt changes in the direction of the scan path are then carried out with the radiation deactivated. Consequently, the time required for these processes cannot be used for the actual irradiation. Dead times also occur during scan vectors which are not geometrically adjacent to each other. In this case, the scanner mirror movements must be carried out with radiation deactivated for repositioning whether skywriting is used or not. The time required for these processes is then also not available for the actual radiation operation.

In an advantageous variant of the suggested method and the associated device, when dynamic beam deflection systems such as galvanometer scanners are used, the separation into individual beams and therewith into the beam deflection devices assigned to the respective individual beams is carried out in alternating manner. The beam deflection devices are then tuned to each other for operation and switching between the beam deflection devices takes place in such manner that while the layer is machined, also described as irradiation in the following text, the dead times described previously are minimised. Then for example when switching between scan vectors which are not adjacent to each other and/or during sudden changes of direction of the scan path switching is carried out between the individual beams or the dynamic beam deflection devices for the individual beams. This can be assured with a fast-acting beam switch. Thus for example when two dynamic beam deflection devices are used corresponding to the separation into two individual beams the radiation can always be guided over surfaces that are to be irradiated by the first beam deflection device, while repositioning, deceleration or acceleration processes are carried out by means of the second beam deflection device. This enables continuous operation of the radiation source used and uninterrupted use of the full radiation output generated by the radiation source for melting the layer. In principle, it is also possible to continue irradiation even while the coating process is in progress.

The suggested method and the associated device may be implemented for all powder-bed based beam fusion methods. Examples of such include Selective Laser Melting (SLM) or Selective Laser Sintering (SLS). Of course this list is by no means exhaustive. The suggested method and the associated device also yield a better degree of utilisation of the beam source used than with the previously known solutions. This enables the irradiation process to be carried out considerably more quickly, at a rate between 15% and 250% faster depending on component geometry and the condition of the system. The method and the device enable practically uninterrupted operation of the beam sources used. The method and the device have significant potential particularly for use in industrial manufacturing environments, and enable the additive manufacture of components with maximised value creation. This results in a substantial increase in productivity of the corresponding manufacturing apparatus and therewith also significant financial advantages, which strongly favour the implementation of powder-bed based beam fusion methods in the context of industrial serial production. In this context, laser beams are used preferably as the energetic beam. However, the method may also be use with other energetic beams such as electron or ion beams.

### BRIEF DESCRIPTION OF THE DRAWING

In the following section, the suggested method and the suggested device will be explained again in greater detail with reference to an exemplary embodiment thereof in conjunction with the drawing. In the drawing:

FIG. 1 is a diagrammatic representation of the process chain in selective laser melting;

FIG. 2 is a diagrammatic representation of an example of the suggested method; and

FIG. 3 shows an example of a different separation of the output to the individual beams.

### WAYS TO REALISE THE INVENTION

In powder-bed based beam fusion methods such as selective laser melting, the value-adding irradiation process is interrupted by processes that do not add value such as layer application, process preparation and follow-up processing. This process chain is represented diagrammatically in FIG. 1, which shows the process preparation 1, layer application 2, irradiation 3 and follow-up processing 4 processes in the defined sequence. The layer application 2 and irradiation 3 processes are repeated one layer at a time until the three-dimensional component is fully constructed. The suggested method and the associated device enable optimisation of the irradiation process in which dead times 5 typically occur, during which the energetic beam does not reach the layer and consequently no irradiation takes place. FIG. 1 indicates schematically the fraction of the irradiation process 2 taken up by the dead times 5. These may be necessitated by acceleration and deceleration phases of the scanner mirrors or due to non-adjacent scan vectors which must be irradiated consecutively. With the suggested method and the associated device, the fraction of these dead times 5 as part of the irradiation process is minimised.

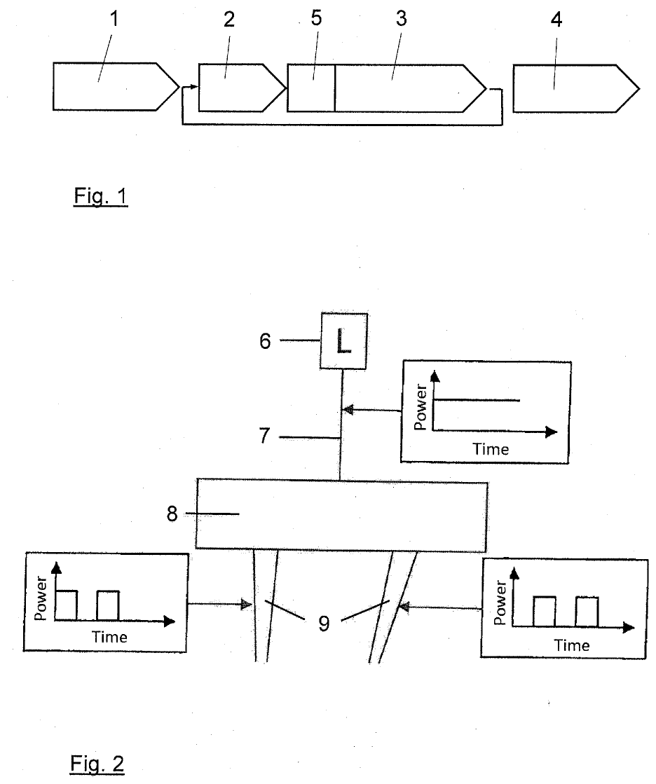

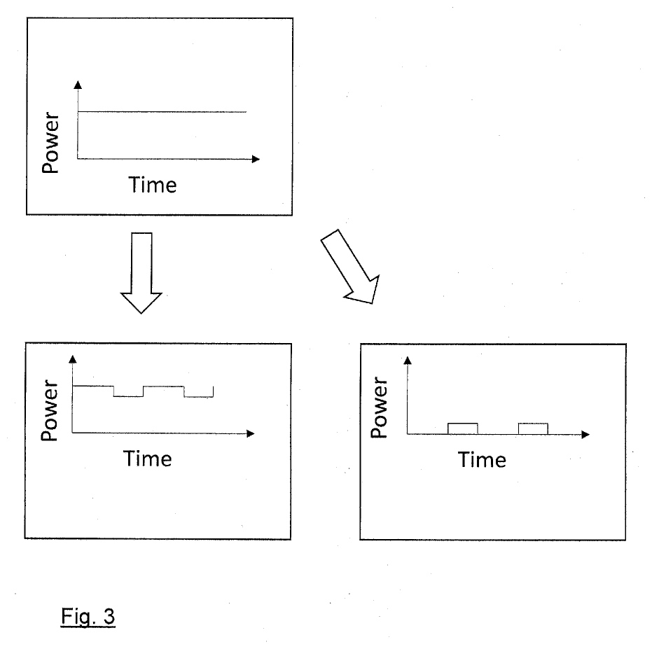

FIG. 2 shows an example of an implementation of the suggested method for this purpose, in which the energetic beam 7 from a laser beam source 6 is separated alternatingly into two individual beams, which impinge on the layer for irradiation at spatially different points. The separation is effected by a beam splitter device 8, which is indicated schematically in the figure. As a result of the temporal modulation of the separation of the energetic beam 7 into two individual beams 9 performed in this example, the power distributions of the individual beams (minus any power losses due to the optical components used) correspond to the original temporal power distribution of the energetic beam 7. The power losses are therefore minimal and the laser power supplied by the laser beam source 6 is used without interruption or at least almost entirely without interruption for the irradiation of the layer for the entire duration of the layer irradiation process. In this regard, the power of the energetic beam 7 generated by the laser—beam source 6 over time is shown in the top part of FIG. 2. The laser beam source 6 is operated in continuous wave (CW) mode. In the lower part of the figure, the power distributions over time for the two individual beams 9 generated by the beam splitter device 8 are depicted on the left and right. The diagrams show the alternating separation of the energetic beam 7 into the two individual beams 9 over time. In this example, a periodic separation over time is evident.

However, this is not essential. The separation over time is selected as a function of the geometry to be irradiated depending on the irradiation task such that melting can be carried out continuously with minimal or no temporal interruption. Thus in one variant for example a separation over time of the continuous radiation may be effected into e.g. n temporally correspondingly offset pulse modulated individual beams with a duty cycle of 1/n, which individual beams are used for melting at different positions by the spatial separation or for repeated irradiation processes, for example pre-heating or post-heating.

In the example shown in FIG. 2, either of the two individual beams 9 may be directed onto the layer to be irradiated for example with a dedicated dynamic beam deflection device, in particular each with a galvanoscanner. A fast-switching beam switch may be used as the beam splitter device, for example. The dead times caused by repositioning, deceleration or acceleration processes may be avoided or reduced by appropriate switching between the two individual beams or galvanoscanners and suitable actuation of these scanners. Thus for example the energetic beam 7 may be guided over the surface to be irradiated via the first galvanoscanner while repositioning, deceleration or acceleration processes are being performed by the second scanner, and vice versa. The other scanner in each case is moved into the requisite position before switching or operated in such manner that it is already in the requisite position when switching is carried out, and can perform the subsequent beam deflection operations before the next switching process without additional acceleration or deceleration. In this way, the dead times represented in FIG. 1 may be reduced considerably. Ideally, corresponding dead times then occur only as a result of switching processes between the individual galvanoscanners or individual beams.

The energetic beam may also be separated in such manner that one of the individual beams continues to deliver an energetic permanent signal, whose power is modulated over time, however (power wobbling), and only the “excess” power is split to another individual beam. The individual beam with the excess power is thus not always present over time. This is represented schematically in FIG. 3, in which the diagram at the top shows the power over time of the energetic beam generated by the laser beam source, and the diagrams at bottom right and left in the figure show the temporal power distributions for the two individual beams generated by the beam splitter device.

### LIST OF REFERENCE SIGNS

1 Process preparation
2 Layer application
3 Irradiation
4 Follow-up processing
5 Dead times
6 Laser beam source
7 Energetic beam
8 Beam splitter device
9 Individual beams

1. Method for machining a material layer using energetic radiation, in particular in order to produce three-dimensional components by melting a particulate material in layers, in which
one or more energetic beams of one or more beam sources are directed onto a layer to be machined and guided over the layer by means of a dynamic beam guidance system in order to machine regions of the layer,
characterized in that
at least one of the energetic beams is separated into multiple individual beams by modulation over time, said individual beams being directed onto the layer to be machined in a spatially separated manner, wherein the separation is carried out in such manner that the sum of the power of the individual beams corresponds to the power of the respective energetic beam minus power losses caused by the separation process.

2. Method according to claim 1,
characterized in that
each individual beam is directed onto the layer to be machined by its own dynamic beam deflection device.

3. Method according to claim 1,
characterized in that
the energetic beam is separated into the individual beams in alternating manner by said modulation over time.

4. Method according to claim 2,
characterized in that
the energetic beam is separated into the individual beams in alternating manner by said modulation over time and is thus separated onto the beam deflection devices, wherein the beam deflection devices are operated in coordination with each other in such manner and the switch between the beam deflection devices is effected in such manner that times for which the beam does not reach the layer during the machining is minimised.

5. Method according to claim 4,
characterized in that
the switch between the beam deflection devices takes place for the energetic beam when changing between non-adjacent scan vectors and/or upon sudden changes of a direction in a machining path.

6. Method according to claim 1,
characterized in that
the energetic beam is separated into two individual beams by modulation over time, of which one individual beam has an amplitude modulation of <100%.

7. Method according to claim 1,
characterized in that
the separation into the individual beams is effected via one or more beam switches for the energetic beam.

8. Method according to claim 1,
characterized in that
the one or more beam sources is/are operated in continuous wave mode.

9. Device for machining a material layer using energetic radiation, in particular in order to produce three-dimensional components by melting a particulate material in layers, including at least:
one or more beam sources which emit one or more energetic beams,
at least one beam splitter device which can separate at least one of the energetic beams into multiple individual beams by modulation over time, and
one or more dynamic beam guidance apparatuses, via which the individual beams can be directed onto a layer to be machined and guided over the layer in order to machine regions of the layer,
wherein the beam splitter device is designed such that the sum of the power of the individual beams corresponds to the power of the respective energetic beam upon separation.

10. Device according to claim 9,
characterized in that
a dedicated dynamic beam deflection device is present for each individual beam, via which the individual beam is directed onto the layer to be machined.

11. Device according to claim 9,
characterized in that
the beam splitter device is designed in such manner that it separates the energetic beam into the individual beams in alternating manner by said modulation over time.

12. Device according to claim 10,
characterized in that
a control unit is present which actuates the beam splitter device and the beam deflection devices in such manner that
the energetic beam is separated into the individual beams and thus also to the beam deflection devices in alternating manner by said modulation over time,
the beam deflection devices are operated in coordination with each other in such manner and
switching between the beam deflection devices is carried out in such manner that times in which the beam does not impinge on the layer during machining of the layer are minimised.

13. Device according to claim 9,
characterized in that
the beam splitter device is embodied such that it separates the energetic beam by the modulation over time into two individual beams, of which one individual beam has an amplitude modulation of <100%.

14. Device according to claim 9,
characterized in that
the beam splitter device includes one or more beam switches.
